(19) United States
(12) Patent Application Publication
(10) Pub. No.: US 2026/0095847 A1
(43) Pub. Date: Apr. 2, 2026

(54) NETWORK ELEMENT DISCOVERING METHOD AND APPARATUS, NETWORK ELEMENT REGISTRATION METHOD AND APPARATUS, AND RELATED DEVICE

(71) Applicant: VIVO MOBILE COMMUNICATION CO., LTD., Dongguan (CN)

(72) Inventors: Sihan CHENG, Dongguan (CN); Weiwei CHONG, Dongguan (CN)

(73) Assignee: VIVO MOBILE COMMUNICATION CO., LTD., Dongguan (CN)

(21) Appl. No.: 19/379,072

(22) Filed: Nov. 4, 2025

Related U.S. Application Data
(63) Continuation of application No. PCT/CN2024/090344, filed on Apr. 28, 2024.

(30) Foreign Application Priority Data
May 4, 2023 (CN) 202310490800.5

(51) Int. Cl. H04W 48/16; H04W 60/00

(52) U.S. Cl. CPC H04W 48/16; H04W 60/00

(57) ABSTRACT

A network element discovering method and apparatus, a network element registration method and apparatus, and a related deviceare provided. The network element discovering method includes: receiving, by a first network element, a first message from a second network element, where the first message is used to request to discover a network element that exposes sensing data; and discovering, by the first network element, a third network element based on the first message, where the third network element is the network element that exposes the sensing data.

### CROSS-REFERENCE TO RELATED APPLICATIONS

This application is a continuation of International Patent Application No. PCT/CN2024/090344, filed on Apr. 28, 2024, which claims priority to Chinese Patent Application No. 202310490800.5 filed in China on May 4, 2023, both of which are incorporated herein by reference in their entireties.

### TECHNICAL FIELD

This application pertains to the field of communication technologies, and specifically relates to a network element discovering method and apparatus, a network element registration method and apparatus, and a related device.

### BACKGROUND

Wireless sensing technologies are widely used in scenarios such as traffic monitoring, weather forecast, rainfall remote sensing, and intrusion detection. Currently, a sensing service (or referred to as a sensing task) may be performed by using a third-party server, and execution of the sensing service needs to be based on acquisition of a large amount of sensing data.

### SUMMARY

Embodiments of this application provide a network element discovering method and apparatus, a network element registration method and apparatus, and a related device.

According to a first aspect, a network element discovering method is provided, where the method is performed by a first network element, and the method includes:
receiving, by the first network element, a first message from a second network element, where the first message is used to request to discover a network element that exposes sensing data; and
discovering, by the first network element, a third network element based on the first message, where the third network element is the network element that exposes the sensing data.

According to a second aspect, a network element discovering method is provided, where the method is performed by a second network element, and the method includes:
sending, by the second network element, a first message to a first network element, where the first message is used to request to discover a network element that exposes sensing data.

According to a third aspect, a network element registration method is provided, where the method is performed by a third network element, and the method includes:
sending, by the third network element, a fourth message to a first network element, where the fourth message is used to request to register related information of the third network element.

According to a fourth aspect, a network element discovering apparatus is provided and is applied to a first network element, and the apparatus includes:
a first receiving module, configured to receive a first message from a second network element, where the first message is used to request to discover a network element that exposes sensing data; and
a discovering module, configured to discover a third network element based on the first message, where the third network element is the network element that exposes the sensing data.

According to a fifth aspect, a network element discovering apparatus is provided and is applied to a second network element, and the apparatus includes:
a first sending module, configured to send a first message to a first network element, where the first message is used to request to discover a network element that exposes sensing data.

According to a sixth aspect, a network element registration apparatus is provided and is applied to a third network element, and the apparatus includes:
a first sending module, configured to send a fourth message to a first network element, where the fourth message is used to request to register related information of the third network element.

According to a seventh aspect, a communication device is provided. The communication device includes a processor and a memory, the memory stores a program or instructions capable of running on the processor, and when the program or the instructions are executed by the processor, the steps of the method according to the first aspect, the second aspect, or the third aspect are implemented.

According to an eighth aspect, a communication device is provided, including a processor and a communication interface. The communication interface is configured to receive a first message from a second network element, where the first message is used to request to discover a network element that exposes sensing data; and the processor is configured to discover a third network element based on the first message, where the third network element is the network element that exposes the sensing data.

Alternatively,
the communication interface is configured to send a first message to a first network element, where the first message is used to request to discover a network element that exposes sensing data.

Alternatively,
the communication interface is configured to send a fourth message to a first network element, where the fourth message is used to request to register related information of the third network element.

According to a ninth aspect, a readable storage medium is provided. The readable storage medium stores a program or instructions. When the program or the instructions are executed by a processor, the steps of the method according to the first aspect are implemented, the steps of the method according to the second aspect are implemented, or the steps of the method according to the third aspect are implemented.

According to a tenth aspect, a wireless communication system is provided, including a first network element, a second network element, and a third network element. The first network element may be configured to perform the steps of the method according to the first aspect, the second network element may be configured to perform the steps of the method according to the second aspect, and the third network element may be configured to perform the steps of the method according to the third aspect.

According to an eleventh aspect, a chip is provided. The chip includes a processor and a communication interface. The communication interface is coupled to the processor. The processor is configured to run a program or instructions, to implement the steps of the method according to the first aspect, the steps of the method according to the second aspect, or the steps of the method according to the third aspect.

According to a twelfth aspect, a computer program product/program product is provided. The computer program product/program product is stored in a storage medium, and the computer program/program product is executed by at least one processor to implement the steps of the method according to the first aspect, the steps of the method according to the second aspect, or the steps of the method according to the third aspect.

In embodiments of this application, a first network element receives a first message from a second network element, where the first message is used to request to discover a network element that exposes sensing data; and the first network element discovers, based on the first message, the network element that exposes the sensing data. Through the foregoing process, the network element that exposes the sensing data can be found.

### BRIEF DESCRIPTION OF DRAWINGS

FIG. 1 is a block diagram of a wireless communication system according to an embodiment of this application;

FIG. 2 is a flowchart of a network element discovering method according to an embodiment of this application;

FIG. 3 is a flowchart of an embodiment according to an embodiment of this application;

FIG. 4 is a flowchart of another embodiment according to an embodiment of this application;

FIG. 5 is a flowchart of a network element discovering method according to an embodiment of this application;

FIG. 6 is a structural diagram of a network element discovering apparatus according to an embodiment of this application;

FIG. 7 is a flowchart of a network element discovering method according to an embodiment of this application;

FIG. 8 is a structural diagram of a network element discovering apparatus according to an embodiment of this application;

FIG. 9 is a flowchart of a network element registration method according to an embodiment of this application;

FIG. 10 is a structural diagram of a network element registration apparatus according to an embodiment of this application;

FIG. 11 is a structural diagram of a communication device according to an embodiment of this application;

FIG. 12 is a schematic diagram of a hardware structure of a terminal according to an embodiment of this application;

FIG. 13 is a schematic diagram of a hardware structure of an access network device according to an embodiment of this application; and

FIG. 14 is a schematic diagram of a hardware structure of a core network device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions, that is, solution 1: including A and not including B; solution 2: including B and not including A; and solution 3: including A and B. The character “/” generally indicates an “or” relationship between associated objects.

The term “indication” in this application may be either a direct indication (or an explicit indication) or an indirect indication (or an implicit indication). A direct indication may be understood as: A transmitter explicitly notifies, in a transmitted indication, a receiver of content such as specific information, an operation that needs to be performed, or a request content. An indirect indication may be understood as: A receiver determines corresponding information based on an indication sent by a transmitter, or performs determining and determines, based on a determining result, an operation that needs to be performed, a request result, or the like.

It should be noted that technologies described in the embodiments of this application are not limited to a Long Term Evolution (Long Term Evolution, LTE)/LTE-Advanced (LTE-Advanced, LTE-A) system, and may further be applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), or other systems. The terms “system” and “network” in the embodiments of this application may be used interchangeably. The technologies described can be applied to both the systems and the radio technologies mentioned above as well as to other systems and radio technologies. A new radio (New Radio, NR) system is described in the following description for illustrative purposes, and NR terms are used in most of the following description, although these technologies can also be applied to communication systems other than the NR system application, such as the 6^{th} generation (6^{th} Generation, 6G) communication system.

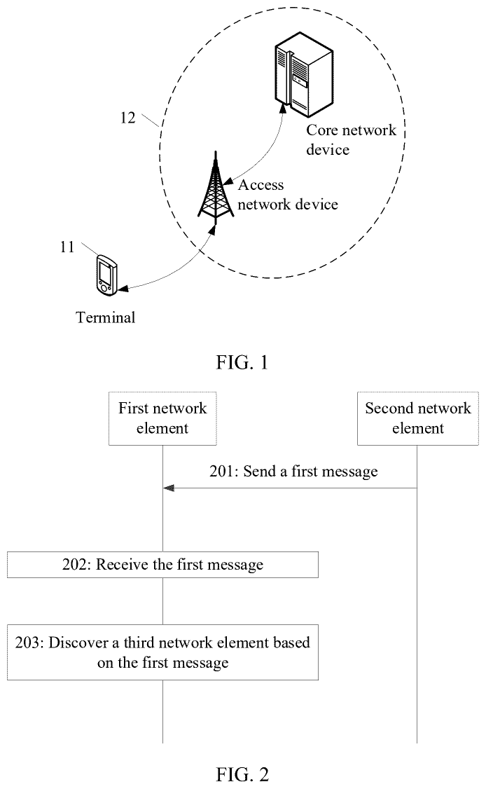

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR) device, a virtual reality (Virtual Reality, VR) device, a robot, a wearable device (Wearable Device), a flight vehicle (flight vehicle), vehicle user equipment (Vehicle User Equipment, VUE), ship-borne equipment, pedestrian user equipment (Pedestrian User Equipment, PUE), a smart home device (a home device with a wireless communication function, such as a refrigerator, a television, a washing machine, or furniture), a game console, a personal computer (Personal Computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. In addition to the foregoing terminal devices, the terminal device may be a chip in a terminal, such as a modem (Modem) chip or a system on chip (System on Chip, SoC). It should be noted that a specific type of the terminal 11 is not limited in the embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, WiFi) node, and the like. The base station may be referred to as a NodeB (Node B, NB), an evolved NodeB (Evolved Node B, eNB), a next-generation node B (the next generation Node B, gNB), a new radio NodeB (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home Node B, HNB), a home evolved NodeB (home evolved Node B), a transmission reception point (Transmission Reception Point, TRP), or another suitable term in the field, provided that a same technical effect is achieved, and the base station is not limited to a specific technical vocabulary. It should be noted that only a base station in an NR system is used as an example in this embodiment of this application for description, and a specific type of the base station is not limited.

The core network device may include but is not limited to at least one of the following: a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF) unit, an edge application service discovery function (Edge Application Server Discovery Function, EASDF), unified data management (Unified Data Management, UDM), unified data repository (Unified Data Repository, UDR), a home subscriber server (Home Subscriber Server, HSS), centralized network configuration (Centralized network configuration, CNC), a network repository function (Network Repository Function, NRF), a network exposure function (Network Exposure Function, NEF), a local NEF (Local NEF or L-NEF), a binding support function (Binding Support Function, BSF), an application function (Application Function, AF), or the like. It should be noted that, in the embodiments of this application, only a core network device in an NR system is used as an example for description, and a specific type of the core network device is not limited.

This application relates to an integrated sensing and communication (Integrated Sensing and Communication, ISAC, ISAC for short) technology, and related introductions of the ISAC technology are first provided below.

Wireless communication and radar sensing (Communication&Sensing, C&S) has been developing in parallel, but an intersection is limited. Wireless communication and radar sensing have many commonalities in terms of signal processing algorithms, devices, and a system architecture to some extent. In recent years, a conventional radar has been developed towards more general wireless sensing. Wireless sensing may broadly retrieve information from received radio signals. For wireless sensing related to a location of a sensing target, dynamic parameters such as a target signal reflection delay, an angle of arrival (Angle of Arrival, AoA), an angle of departure (Angle of Departure, AoD), and Doppler may be estimated by using a common signal processing method. A physical feature of a sensing target may be implemented by measuring an inherent mode signal of a measurement device, an object, and an activity. These two sensing manners may be respectively referred to as sensing parameter estimation and pattern recognition. In this sense, wireless sensing refers to more general sensing techniques and applications using radio signals.

Integrated sensing and communication has the potential to integrate wireless sensing into large-scale mobile networks, which are referred to as perceptive mobile networks (Perceptive Mobile Networks, PMNs) herein. The PMN may evolve from a current 5G mobile network, and is expected to become a ubiquitous wireless sensor network, and provide a stable and high-quality mobile communication service. The PMN can be built on a mobile network infrastructure in related technologies without major changes to network structures and devices. The PMN will free up a maximum capacity of a mobile network and avoid spending high infrastructure costs to build a new wide area wireless sensor network separately. With the expansion of a coverage range, an integrated communication and sensing capability is expected to implement many new applications. A sensing mobile network can provide both communication and wireless sensing services, and due to a large broadband coverage range and a powerful infrastructure, the sensing mobile network can become a pervasive wireless sensing solution. The sensing mobile network improves the productivity of society with its coordinated communication and sensing capabilities and helps generate new applications that sensor networks in a large number of related technologies cannot effectively implement. Some early work on passive sensing using a mobile signal has proven its potential, for example, GSM-based radio signal traffic monitoring, weather forecast, and rainfall remote sensing. The sensing mobile network can be widely used in communication and sensing in transportation, communication, energy, precision agriculture, and safety. Solutions in related technologies are either infeasible or inefficient. The sensing mobile network also provides complementary sensing capabilities for a sensor network in a related technology, featuring unique day-and-night operations and the ability to penetrate fog, foliage, and even solid objects.

In a related technology, an independent sensing system needs to be disposed for a third-party server to obtain sensing data, and acquisition of the sensing data requires relatively large investment. It can be learned that there is a problem of relatively high costs of obtaining sensing data in the related technology. Based on the foregoing advantages of the integrated sensing and communication technology, this application provides a network element discovering method and apparatus, a network element registration method and apparatus, and a related device, to resolve a problem of relatively high costs for a third-party server to obtain sensing data in a related technology.

FIG. 2 is a flowchart of a network element discovering method according to an embodiment of this application. As shown in FIG. 2, the network element discovering method includes the following steps.

Step 201: A second network element sends a first message to a first network element, where the first message is used to request to discover a network element that exposes sensing data.

Step 202: The first network element receives the first message from the second network element.

Step 203: The first network element discovers a third network element based on the first message, where the third network element is the network element that exposes the sensing data.

In this embodiment of this application, the first network element may be a network element having a storage function, and the first network element may store network element information, so as to have a capability and a condition of discovering a network element. The first network element may be a network element of a core network. The first network element may be, for example, an NRF.

The second network element can communicate and interact with the first network element, and request the first network element to discover the network element that exposes the sensing data. From the perspective of request initiation, the second network element may be a request initiator, that is, the second network element directly initiates a network element discover request to the first network element. Alternatively, the second network element may not be a request initiator. In this case, the second network element serves as an intermediate requester, that is, another network element first sends a network element discover request to the second network element, and then the second network element sends the network element discover request to the first network element. From the perspective of a sensing data requirement, the second network element may be a sensing data demander (or referred to as a consumer, a consumer network element, or a consumer network device), or may not be a sensing data demander. The second network element may alternatively be a network element that may initiate a sensing related service request. The second network element may be an untrusted third-party service server, a trusted service server, a terminal device, a core network element, or the like. The second network element may be, for example, an NEF, a network data analytics function (Network Data Analytics Function, NWDAF), or an application function (Application Function, AF).

The third network element is the network element that exposes the sensing data, and the third network element may be understood as a network element that can obtain the sensing data and can provide the sensing data for another network element, that is, a sensing data provider. The third network element may alternatively be a network element with a sensing function. The third network element may be, for example, a terminal, an access network device, or another sensing network element. The third network element may be, for example, a sensing function (Sensing Function, SF).

In this embodiment of this application, a first network element receives a first message from a second network element, where the first message is used to request to discover a network element that exposes sensing data; and the first network element discovers, based on the first message, the network element that exposes the sensing data. Through the foregoing process, the network element that exposes the sensing data can be found. In this way, the sensing data can be provided by using the network element that exposes the sensing data, thereby reducing costs of obtaining the sensing data.

In some embodiments, the first message includes at least one of the following information:
first information, used to indicate expected sensing data, where the first message is used to request to discover a network element whose sensing data matches the first information;
second information, used to indicate an expected sensing service category, where the first message is used to request to discover a network element whose sensing service category matches the second information; or
third information, used to indicate an expected sensing range, where the first message is used to request to discover a network element whose sensing range matches the third information.

The first information may be understood as requirement information used to indicate the sensing data, and the requirement information is used to indicate sensing data that a found network element is expected to expose (or provide).

It should be noted that the sensing service category may also be described as a category of a sensing service.

Optionally, the first information includes at least one of the following:
information used to indicate an expected sensing data category; or
information used to indicate an expected sensing data type.

When the first information includes the information used to indicate the expected sensing data category, the first information is used to indicate that a sensing data category that a found network element is expected to expose (or provide) is sensing data of the expected sensing data category.

Correspondingly, when the first information includes the information used to indicate the expected sensing data type, the first information is used to indicate that a data type that a found network element is expected to expose (or provide) is sensing data of the expected sensing data type.

It should be noted that the sensing data category may also be described as a category of the sensing data, and the sensing data type may also be described as a data type of the sensing data.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

The sensing measurement data may also be referred to as a sensing measurement value (Sensing Measurement), and refers to measurement data obtained after the sensing measurement device measures a received signal or original channel information, for example, reference signal received power (Reference Signal Received Power, RSRP), a signal-to-noise ratio (Signal-to-Noise Ratio, SNR), minimization of drive test (Minimization of Drive Test, MDT) measurement data, and channel state information (Channel State Information, CSI) measurement data. The processing may be simple data annotation or the like, for example, receiving information data or channel response data.

The sensing intermediate data may also be referred to as a sensing intermediate result (Sensing Result), and refers to data obtained after the SF performs further processing on the sensing measurement data. A processing operation may be data desensitization processing, aggregation calculation processing, security encryption processing, or the like. The sensing intermediate data may be applicable to one or more specific sensing services, and the sensing intermediate data is processed as input data by a downstream node or device to obtain a final service-layer sensing service result. For example, the sensing intermediate data is a rate, a location, an acceleration, and a size of an object, such as signal strength, a delay, Doppler, an angle, or a multi-dimensional combination representation thereof.

The sensing service result may also be referred to as a sensing service result, a sensing objective (Sensing Objective), or the like, and refers to application-layer (application layer) data obtained by the SF by processing sensing measurement data or sensing intermediate data based on specific sensing service logic. The sensing service result may be exposed to a consumer for direct use, and the consumer does not need to understand internal logic of a sensing service. For example, the sensing service result is a weather monitoring result (specific weather), intrusion detection (whether an object intrudes), whether a target exists, a target location, an action, a heartbeat, or an imaging result.

For example, for a weather prediction task, sensing measurement data may be received signal data or channel response data, sensing intermediate data may be data obtained based on further processing of two pieces of measurement data, for example, sensing strength, and a sensing service result may be data obtained by further processing, inference, or the like, for example, a specific weather result (sunny, rainy, and the like).

It should be noted that, although the sensing service result is obtained after further processing than the sensing intermediate data, the sensing service result is not necessarily generated based on the sensing intermediate data, that is, the sensing service result may also be directly processed based on raw data such as the sensing measurement data.

The sensing data category may alternatively be a container (container) category. A container is a storage form in which data is packaged and encapsulated. Because the container is unreadable and incomprehensible to an intermediate network element (that is, the intermediate network element cannot know specific content of the container), security and privacy of the container are higher, and data that can be carried when a sensing data demander interacts with a sensing data provider may be more complete or may be in a larger quantity. An internal specific data type of the container is invisible, and therefore, information such as a specific data category or a specific data type of the container does not need to be specified. When the sensing data category includes the container category, it indicates that the sensing data demander supports obtaining the sensing data in this manner, or indicates that a sensing data provider expects a found network element can expose (or provide) the sensing data in this manner.

Optionally, the sensing data type includes at least one of received signal data, channel response data, signal strength data, delay data, Doppler data, angle data, weather monitoring data, intrusion detection data, target location data, action data, heartbeat data, or imaging result data.

Optionally, the sensing data type further includes an event identifier and the like, and represents data related to an event.

The sensing data type may be displayed in a form of a list, or may be displayed in another form.

It should be noted that the sensing data type may correspond to the foregoing sensing data category. For example, the sensing data category is sensing intermediate data and a sensing service result, a sensing data type corresponding to the sensing intermediate data includes signal strength, a delay, Doppler, and the like, and a sensing data type corresponding to the sensing service result includes a weather monitoring result (specific weather), a target location, an action, a heartbeat, an imaging result, and the like.

The second information is used to indicate a sensing service category that a found network element is expected to support, such as weather monitoring and target monitoring.

The third information is used to indicate a sensing range that a found network element is expected to support, including a time range, a region range (such as a cell), a sensing precision range (such as processing precision for the sensing data or region precision (such as a tracking area (Tracking Area, TA), a cell (cell), or a below cell level (below cell level)) of a sensing range), and the like.

In addition, the first message may further include information used to indicate a network element type, and is used to indicate a type to which a found network element is expected to belong, such as an SF.

In some embodiments, that the first network element discovers a third network element based on the first message includes at least one of the following:
the first network element discovers, based on the first information, a third network element whose exposing sensing data information matches the first information;
the first network element discovers, based on the second information, a third network element whose sensing service category matches the second information; or
the first network element discovers, based on the third information, a third network element whose sensing range matches the third information.

In addition, when the first message includes the information used to indicate the network element type, the first network element may further discover, based on the information, a third network element whose network element type matches the information.

Herein, the third network element whose exposing sensing data information matches the first information may be understood as: Sensing data that the third network element supports exposing meets expected sensing data. The third network element whose sensing service category matches the second information may be understood as: A sensing service category of the third network element meets an expected sensing service category. The third network element whose sensing range matches the third information may be understood as: A sensing service category of the third network element meets an expected sensing range.

In this embodiment of this application, the foregoing information is carried in the first message, so that precise matching between a sensing data provider and a sensing data demander can be implemented, and a found third network element that exposes the sensing data can meet a requirement of the sensing data demander, thereby meeting a requirement of the sensing data demander for the sensing data.

It should be noted that, a related requirement for exposing the sensing data may be agreed upon by using a protocol, or a related requirement for exposing the sensing data is configured by using a network, and both the sensing data provider and the sensing data demander know the related requirement. In this way, the sensing data demander may not need to indicate information such as the first information, the second information, and the third information, and a third network element that is found by the first network element and that exposes the sensing data can meet a requirement of the sensing data demander.

In addition, even if the related requirement for exposing the sensing data is not agreed upon in the protocol, and the network does not configure the related requirement for exposing the sensing data, the sensing data demander may not indicate information such as the first information, the second information, or the third information, but simply initiate a network element discover request. In this way, after the first network element provides the found third network element that exposes the sensing data, the sensing data demander may further exchange with the third network element found by the first network element, so as to discover a network element that meets the requirement of the sensing data demander.

In some embodiments, the first network element sends a second message to the second network element when the third network element is found, and the second message includes information used to indicate the third network element.

When discovering the third network element based on the first message, the first network element may discover, based on information such as requirement information carried in the first message, a network element whose exposing sensing data information matches the requirement information. For example, the first network element discovers, based on sensing data category information in the requirement information, a network element that matches this information, where a network element that matches the sensing data category information is a network element that supports an exposure sensing data category. When the third network element is found, the first network element may feed back information about the third network element.

Optionally, the second message further includes at least one of the following information:
information used to indicate a sensing data category that the third network element supports exposing; information used to indicate a sensing data type that the third network element supports exposing;
information used to indicate a sensing service category supported by the third network element; or
information used to indicate a sensing range supported by the third network element.

When feeding back the information about the third network element, the first network element may carry information such as information of the sensing data category (which may be understood as exposing sensing data information) and the sensing data type that the third network element supports exposing, and the sensing service category and the sensing range that are supported by the third network element. In addition, the first network element may further carry information such as type information of the third network element, an identifier of a third network element instance, address information of the third network element, service information supported by the third network element, and capability information of the third network element.

Specifically, the first network element determines, based on stored exposing sensing data information, whether one or more third network elements can expose the sensing data to the sensing data demander. If exposing sensing data information of the one or more third network elements matches requirement information expected by the sensing data demander, the first network element determines that the one or more third network elements can expose the sensing data to the sensing data demander. On the contrary, the first network element determines that no third network element can expose the sensing data to the sensing data demander.

In some embodiments, the method further includes:
sending, by the first network element, a third message to the second network element when no network element that exposes the sensing data is found, where the third message is used to indicate that no network element that exposes the sensing data is found.

Specifically, the first network element sends the third message to the second network element when no network element whose exposing sensing data information matches the first information is found, and the third message is used to indicate that no network element whose exposing sensing data information matches the first information is found.

Specifically, the first network element sends the third message to the second network element when no network element whose sensing service category matches the second information is found, and the third message is used to indicate that no network element whose sensing service category matches the second information is found.

Specifically, the first network element sends the third message to the second network element when no network element whose sensing range matches the third information is found, and the third message is used to indicate that no network element whose sensing range matches the third information is found.

In this embodiment of this application, the network element that exposes the sensing data may register capability information of the network element (a capability of exposing data (or content) to the outside) with the first network element for consumers to select and use. A related processes of network element registration is described below.

In some embodiments, the method further includes:
sending, by the third network element, a fourth message to a first network element, where the fourth message is used to request to register related information of the third network element; and
receiving, by the first network element, the fourth message from the third network element.

The fourth message may be referred to as a registration request message. In addition to mandatory information for network element registration in a related technology, the registration request message may further include capability information of a network element, for example, information such as a category of sensing data that can be exposed, a type of sensing data that can be exposed (for example, specific data, a delay, Doppler, or an angle), a supported sensing service category, and a supported sensing range. The network element registration information may further include: a network element type (for example, indicating that the network element is an SF network element), an identifier of a network element instance (used to indicate a specific network element), address information of the network element (for example, a fully qualified domain name (Fully Qualified Domain Name, FQDN) or an IP address (address) of the network element, where the address information of the network element may be used to connect to the network element or the like), and service information supported by the network element. The network element registration information may further include the following fourth information to sixth information and the like.

It should be noted that the “that can be exposed”, “support exposing”, “supported”, and “exposed”in this specification are expressed as similar meanings and can be interchanged.

It should be noted that “that can be exposed”, “support exposing”, “supported”, and “exposed” in this specification may be implicitly embodied, such as being represented, by using a signaling name or in another manner, as information supported by the third network element.

After receiving the registration request message, the first network element may store related information of the third network element.

It should be noted that the first network element may receive registration requests of a plurality of third network elements, and the foregoing matching may be matching a plurality of (target) third network elements or one (target) third network element.

In some embodiments, the related information of the third network element includes at least one of the following:
fourth information, used to indicate exposing sensing data information of the third network element;
fifth information, used to indicate a sensing service category supported by the third network element; or
sixth information, used to indicate a sensing range supported by the third network element.

Optionally, the exposing sensing data information includes at least one of the following:
information used to indicate a sensing data category that the third network element supports exposing; or
information used to indicate a sensing data type that the third network element supports exposing.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

Optionally, the data type includes at least one of received signal data, channel response data, signal strength data, delay data, Doppler data, angle data, weather monitoring data, intrusion detection data, target location data, action data, heartbeat data, or imaging result data.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

After the first network element notifies, by using the second message, the second network element that information indicating that the third network element is found, the second network element may further interact with the third network element to obtain the sensing data. Interaction between the second network element and the third network element is described below.

In some embodiments, the method further includes:
sending, by the second network element, a fifth message to the third network element based on the second message, where the fifth message is used to request the sensing data;
receiving, by the third network element, the fifth message from the second network element;
sending, by the third network element, the sensing data to the third network element based on the fifth message; and
receiving, by the second network element, the sensing data from the third network element.

Optionally, the fifth message includes seventh information, and the seventh information is used to indicate expected sensing data.

Optionally, the fifth message is used to request sensing data that matches the seventh information.

For example, the second network element sends a sensing task request to the third network element, and requests to obtain data corresponding to a target sensing task, and the third network element obtains corresponding sensing data based on the target sensing task and processes the corresponding sensing data, to generate a sensing service result.

When sending the sensing task request to the third network element, the second network element may carry a sensing service category to indicate a sensing service to be performed, or carry a sensing range to indicate a requirement of the sensing service, so as to further describe a specific sensing service. When the third network element may support exposing a plurality of sensing data categories, a plurality of sensing data types, and the like, the second network element may further carry information such as a requested sensing data category and a sensing data type, so as to indicate a transmission form, a specification, or a level of the sensing data.

After receiving the sensing task request, the third network element may complete the sensing task based on information in the sensing task request, and feed back a result of the sensing task. As an example, the third network element may perform a corresponding sensing service procedure based on a specific sensing service type or identifier (Specific sensing service type/ID), including but not limited to: sensing mode selection, sensing device selection, sensing task signaling sending, and sensing data obtaining and collection.

As described above, the second network element may not be a sensing data demander, for example, the second network element is an NEF. In this case, the second network element may further interact with the sensing data demander (that is, a fourth network element, such as an AF). Interaction between the second network element and the fourth network element is described below.

In some embodiments, the second network element is an NEF.

Before the second network element sends the first message to the first network element, the method further includes:
sending, by a fourth network element, a sixth message to the second network element, where the sixth message is used to request to discover the network element that exposes the sensing data; and
receiving, by the second network element, the sixth message from the fourth network element.

The fourth network element is a consumer network element. When the fourth network element is a third-party application, the fourth network element cannot directly communicate with the first network element. In this case, the fourth network element may request, by using the second network element, to discover the network element that exposes the sensing data.

As an example, the fourth network element sends a request message to the second network element, requests to perform a sensing service, and the like, and may carry requirement information. Specifically, the fourth network element may send a sensing network element discover message (which is used to request to discover a third network element corresponding to a specific sensing service), a sensing service request message (which is directly used to request to perform a specific sensing service to obtain sensing information), or a sensing data request message (which is directly used to request sensing data information for performing a specific sensing service) to the second network element. The second network element sends a network element query request message such as an Nnrf_NFDiscovery_Request service operation (service operation) to the first network element based on a request of the fourth network element. The requirement information may include requirement information of the sensing data category, requirement information of the sensing data type, requirement information of the sensing service category, requirement information of the sensing range, and the like.

In this embodiment of this application, the second network element may complete, by using the found third network element, a task requested by the fourth network element, and feed back a sensing task result, network element information of the third network element, the sensing data, and the like to the fourth network element. The following provides related descriptions of feeding back, by the second network element, the network element information of the third network element to the fourth network element and feeding back the sensing data to the fourth network element.

In some embodiments, after the second network element receives the second message from the first network element, the method further includes:
sending, by the second network element, a seventh message to the fourth network element, where the seventh message includes information used to indicate the third network element, and the third network element is the network element that exposes the sensing data.

In addition, the method further includes:
sending, by the fourth network element, an eighth message to the third network element based on the seventh message, where the eighth message is used to request the sensing data;
receiving, by the third network element, the eighth message from the fourth network element; and
sending, by the third network element, the sensing data to the fourth network element based on the eighth message.

In some embodiments, after the receiving, by the second network element, the sensing data from the third network element, the method further includes:
sending, by the second network element to the fourth network element, the sensing data received by the second network element.

For better understanding of the technical solutions of this application, the following provides specific embodiments for example description of the network element discovering method in this application. In addition, it should be noted that for details not described in the method embodiment corresponding to FIG. 2, reference may be made to related descriptions of any one of the following embodiments. Related descriptions of any one of the following embodiments are applicable to the method embodiment corresponding to FIG. 2. To avoid repetition, details are not described again.

### Embodiment 1

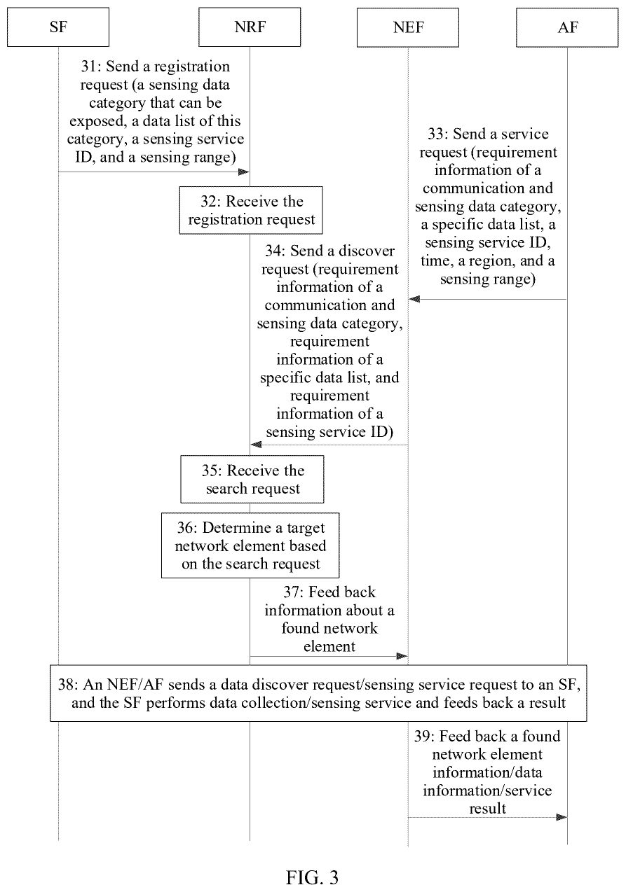

As shown in FIG. 3, the following steps are included.

Step 31: An SF registers network element information of the SF with an NRF network element.

The SF may alternatively be a network element with a sensing function.

The NRF network element may alternatively be an NEF, another network element with a storage function, or the like, or may be an NEF, an AMF, a UDM, another network element with a storage function, or the like.

Specifically, the SF sends a registration request to the NRF, and the registration request is used to request to register information about the SF with the NRF. In addition to mandatory information for network element registration in a related technology, the registration request may further include capability information of the network element, such as a data category that can be exposed, a data list that can be exposed (such as specific data, a delay, Doppler, or an angle), a supported sensing service category, and sensing range information.

Network element registration information in the related technology includes: a network element type (for example, indicating that the network element is an SF network element), an identifier of a network element instance (used to indicate a specific network element), address information of the network element (for example, an FQDN or an IP address of the network element, used to connect to the network element or the like), and service information supported by the network element.

Newly added registration information includes a sensing data category, a sensing data list, sensing range information, and a sensing service category.

The sensing data category is used to indicate a data type (type) that supports being exposed. For example, when the sensing data may be classified into several categories: sensing measurement data, sensing intermediate data, and a sensing service result, the sensing data category may be one of these categories, or a combination of a plurality of categories. For example, if the sensing data category includes the sensing intermediate data and the sensing service result, it indicates that the network element supports exposing data of a sensing result level, data of a sensing target level, and the like.

The sensing measurement data is measurement data obtained after a sensing measurement device measures a received signal or original channel information, for example, RSRP, an SNR, MDT measurement data, or CSI measurement data. The processing may be simple data annotation or the like, for example, receiving information data or channel response data. The sensing measurement data may also be referred to as a sensing measurement value (Sensing Measurement).

The sensing intermediate data refers to data obtained after the SF performs further processing on the sensing measurement data. A processing operation may be data desensitization processing, aggregation calculation processing, security encryption processing, or the like. The intermediate data may be applicable to one or more specific sensing services, and the sensing intermediate data is processed as input data by a downstream node or device to obtain a final service-layer sensing service result. For example, the sensing intermediate data is a rate, a location, an acceleration, and a size of an object, such as signal strength, a delay, Doppler, an angle, and/or a multi-dimensional combination representation thereof. The sensing intermediate data may also be referred to as a sensing intermediate result (Sensing Result).

The sensing service result refers to an application-layer (application layer) sensing service result obtained after the SF processes the sensing measurement data or the sensing intermediate data based on specific sensing service logic. The result data may be exposed for direct use by consumers, and the consumers may not need to understand internal logic of a sensing service. For example, the sensing service result is a weather monitoring result (specific weather), intrusion detection (whether an object intrudes), whether a target exists, a target location, an action, a heartbeat, or an imaging result. The sensing service result may also be referred to as a sensing objective, a sensing purpose, or the like.

For example, for a weather prediction task, a sensing measurement value may be received signal data and/or channel response data, sensing intermediate data may be sensing strength obtained based on further processing of two measurement values, and a sensing service result may be further processing, inference, or the like, for example, a specific weather result (sunny, rainy, and the like).

It should be noted that, although the sensing service result is obtained after further processing than the sensing intermediate data, the sensing service result is not necessarily generated based on the sensing intermediate data, that is, the sensing service result may also be directly processed based on raw data such as the sensing measurement value.

In addition, the sensing data category may alternatively be a container (container) or the like.

The sensing data list is used to indicate a specific data type that supports being exposed. The sensing data list may be or may not be displayed in a form of a list.

Specifically, for example, the sensing data list is the foregoing received signal data, channel response data, signal strength, delay, Doppler, angle, weather monitoring result (specific weather), intrusion detection (whether an object intrudes), whether a target exists, a target location, an action, a heartbeat, an imaging result, a multi-dimensional combination representation thereof, and/or the like.

It should be noted that the sensing data information may correspond to the foregoing sensing data category. For example, the sensing data category that supports being exposed is sensing intermediate data and a sensing service result, a sensing data list corresponding to the sensing intermediate data includes signal strength, a delay, Doppler, and the like, and a sensing data list corresponding to the sensing service result includes a weather monitoring result (specific weather), a target location, an action, a heartbeat, an imaging result, and the like.

The sensing range information is used to indicate a sensing range supported by the network element. The sensing range information may include a time range, a region range (for example, a specific cell), a sensing precision range (for example, processing precision for sensing data, and/or region precision (for example, a TA, a cell, or a below cell level) for a sensing range), and the like. The time range is a time period or a time point in which the SF can provide a sensing service. The region range is a region in which the SF can provide a sensing service, and the region may be a service region of the SF or a sub-region of an SF service region.

The sensing service category is used to indicate a sensing service type that the SF can support (can complete), such as weather monitoring and target monitoring. For different sensing services, the SF may have same or different sensing service capability exposure information. Types of sensing services may be represented in different manners such as sensing service type or sensing service ID.

It should be noted that the foregoing information such as the sensing data category, the sensing data list, and the sensing range may alternatively correspond to the sensing service category. In other words, for different sensing service categories, different sensing data categories may be supported.

Step 32: The NRF receives the registration request and stores the registration request.

Step 33: A network device such as an AF may serve as a consumer network element to execute a request such as a sensing service or sensing data to the NEF.

The AF may alternatively be another network element that may initiate a sensing related service request, or another device (such as an external server), and may be referred to as a consumer, a consumer network element, a consumer network device, or the like.

The consumer may alternatively be a non-trusted third-party service server, a trusted service server, a terminal device, an intra-network network element, or the like.

The NEF may alternatively be another network element with an exposure capability, or the like.

When the AF is a trusted service server, the AF directly initiates a request message such as an Nnrf_ NFDiscovery_Request service operation or Nnrf_NFManagement_NFStatusSubscribe (status subscription) to the NRF. (This may be considered as Embodiment 2)

Specifically, the AF sends a request message to the NEF, requests to perform a sensing service, and the like, and may carry requirement information. Specifically, the AF may send a sensing network element query message (which is used to request to discover SF instances corresponding to a specific sensing service), a sensing service request message (which is directly used to request to perform a specific sensing service to obtain sensing information), or a sensing data request message (which is directly used to request sensing data information for performing a specific sensing service) to the NEF. The NEF sends a network element query request message such as an Nnrf_NFDiscovery_Request service operation to the NRF based on the request of the AF. The requirement information may include requirement information of a sensing data category, requirement information of a specific sensing data list, requirement information of a sensing service category, requirement information of a sensing range, and the like.

The requirement information of the sensing data category is used to indicate a sensing data category required by the AF network element. For example, when the sensing data may be classified into several categories: sensing measurement data, sensing intermediate data, and a sensing service result, the sensing data category may be one of these categories, or a combination of a plurality of categories.

The requirement information of the sensing data list is used to indicate specific sensing data information required by the AF network element,
for example, received signal data, channel response data, signal strength, delay, Doppler, angle, weather monitoring result (specific weather), intrusion detection (whether an object intrudes), whether a target exists, a target location, an action, a heartbeat, an imaging result, a multi-dimensional combination representation thereof, and/or the like.

The requirement information of the sensing service category is used to indicate a sensing service category to be performed by the AF network element, such as weather monitoring and target monitoring.

The requirement information of the sensing range is used to indicate range information corresponding to a sensing service to be performed by the AF network element. The range information may include a time range, a region range (for example, a specific cell), a sensing precision range (for example, processing precision for sensing data, and/or region precision (for example, a TA, a cell, or a below cell level) for a sensing range), and the like.

Step 34: After receiving a request from a consumer network element, the NEF may discover a network element from the NRF, and carry information similar to that in step 3. Specifically, after receiving a sensing task request of the AF, the NEF may send a network element discover request to the NRF based on the sensing task request of the AF, to request a network element that can meet the requirement information.

The network element discover request sent by the NEF to the NRF may carry the requirement information. Specifically, the requirement message is used to indicate information that a found network element is expected to support, for example, target sensing data category information, target sensing data list information, target sensing service category information, and target sensing range information.

The target sensing data category information is used to indicate sensing data category information that a found network element is expected to support. For example, when the sensing data may be classified into several categories: sensing measurement data, sensing intermediate data, and a sensing service result, the sensing data category may be one of these categories, or a combination of a plurality of categories.

The target sensing data list information is used to indicate sensing data list information that a found network element is expected to support, for example, received signal data, channel response data, signal strength, delay, Doppler, angle, weather monitoring result (specific weather), intrusion detection (whether an object intrudes), whether a target exists, a target location, an action, a heartbeat, an imaging result, a multi-dimensional combination representation thereof, and/or the like.

The target sensing service category information is used to indicate sensing service category information and the like that a found network element is expected to support, such as weather monitoring and target monitoring.

The target sensing range information is used to indicate sensing range information that a found network element is expected to support. The sensing range information may include a time range, a region range (for example, a specific cell), a sensing precision range (for example, processing precision for the sensing data, and/or region precision (for example, a TA, a cell, or a below cell level) for a sensing range), and the like.

The target network element type information is used to indicate a type to which a found network element is expected to belong, for example, an SF network element,
or a network element such as an NWDAF performs a network element discover request to the NRF, and carries similar information.

Step 35 to step 37: After receiving the discover request, the NRF finds a target network element, and feeds back the target network element to the NEF, the NWDAF, and the like.

Specifically, after receiving the network element discover request transferred by the NEF in step 34, the NRF discovers the target network element based on the requirement information in the discover request, and after finding the target network element, feeds back information about the target network element to a network element that sends the discover request to the NRF, that is, the NEF.

When discovering the target network element based on the requirement information in the discover request, the NRF may discover, based on the requirement information, for a network element that matches the requirement information. For example, the network element that matches the information is found based on the target sensing data category information in the requirement information, that is, a network element that supports exposing a target sensing data category.

When the network element information is fed back, network element type information, an identifier of a network element instance, address information of the network element, service information supported by the network element, capability information of the network element, and the like may be carried. A sensing data category, a data list, a supported sensing service category, sensing range information, and the like may also be carried.

Specifically, the NRF determines, based on stored sensing service capability exposure information, whether one or more SF entities can expose the sensing data to the AF. If sensing service capability exposure information of the one or more SFs matches AF information and expected SF information that are included in the network element query message, the NRF determines that the one or more SF entities can expose the sensing data to the AF. On the contrary, the NRF determines that no SF entity can expose the sensing data to the AF.

If it is determined that no SF entity can expose the sensing data to the AF, the NRF sends a query response message to the AF network element, including at least one of the following:
first indication information used to indicate that an SF entity that can expose the sensing data to the AF is not found or does not exist; or
reason information used to indicate a reason why an SF entity that can expose the sensing data to the AF is not found or does not exist. For example, a sensing data type of a consumer is not allowed, or a use range of a consumer is not allowed.

Step 38: After receiving the network element information, the NEF may interact with the SF to obtain the sensing data. Specifically, the NEF sends a sensing task request to the SF to request to obtain data corresponding to a target sensing task, and the SF obtains corresponding data based on the sensing task and processes the corresponding data, to generate a sensing service result.

When the NEF sends the sensing task request to the SF, the sensing service category may be carried, and is used to indicate a sensing service to be performed; the sensing range information is used to indicate a requirement of the sensing service, and further describes a specific sensing service; (for a case that the SF may support exposing a plurality of sensing data categories, a sensing data list, or the like) the NEF may further carry a requested sensing data category and a sensing data list, to indicate a transmission form, a specification, a level, and the like of the sensing data.

After receiving the sensing task request, the SF needs to complete the sensing task based on information in the sensing task request, and feed back a result of the sensing task.

The SF performs a corresponding sensing service process based on a specific sensing service type/ID, including but not limited to: sensing mode selection, sensing device selection, sensing task signaling sending, and sensing data obtaining and collection.

Alternatively, the NWDAF obtains the SF information in step 37, and requests to obtain data from the SF, and the like.

Step 39: The NEF completes, by using a found SF network element, a task requested by the AF, and feeds back a sensing task result, network element information, the sensing data, and the like.

### Embodiment 2

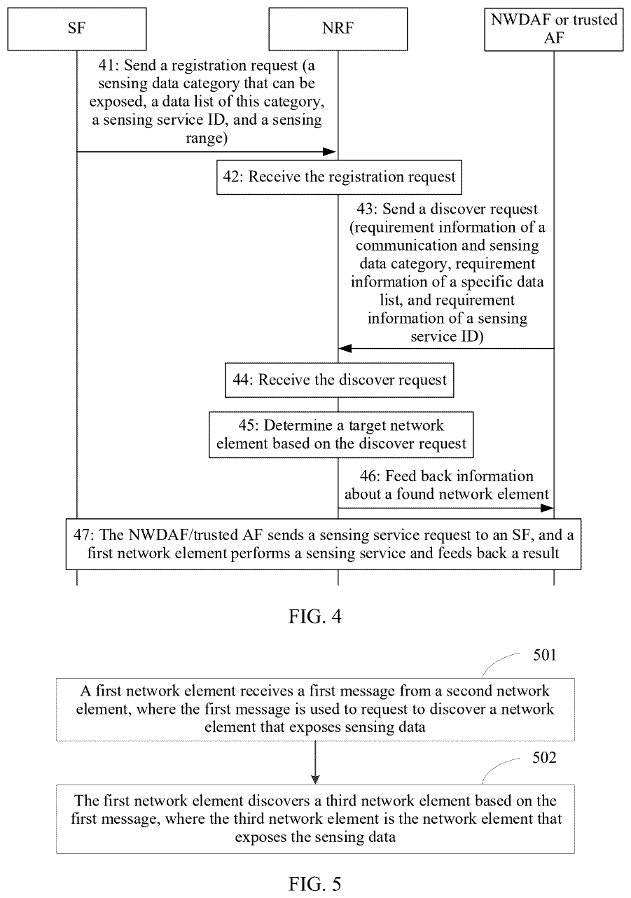

As shown in FIG. 4, Embodiment 2 is similar to Embodiment 1, and a difference lies in that the second network element is an NWDAF or a trusted AF in this embodiment. The second network element may be another internal network element of a core network, a trusted external network element, or the like.

In this embodiment, the second network element does not need to receive a trigger by a network element such as an AF, and may actively send a discover request to an NRF network element.

In conclusion, in this embodiment of this application, through the foregoing process, the network element that exposes the sensing data can be found. In this way, the sensing data can be provided by using the network element that exposes the sensing data, thereby reducing costs of obtaining the sensing data.

With reference to the accompanying drawings, the following describes in detail a network element discovering method, a network element discovering apparatus, a network element registration method, a network element registration apparatus, a first network element, a second network element, and a third network element that are provided in the embodiments of this application.

FIG. 5 is a flowchart of a network element discovering method according to an embodiment of this application. As shown in FIG. 5, the network element discovering method includes the following steps.

Step 501: A first network element receives a first message from a second network element, where the first message is used to request to discover a network element that exposes sensing data.

Step 502: The first network element discovers a third network element based on the first message, where the third network element is the network element that exposes the sensing data.

Optionally, the first message includes at least one of the following information:
first information, used to indicate requirement information of the sensing data, where the first message is used to request to discover a network element whose exposing sensing data information matches the first information;
second information, used to indicate a sensing service category, where the first message is used to request to discover a network element whose sensing service category matches the second information; or
third information, used to indicate a sensing range, where the first message is used to request to discover a network element whose sensing range matches the third information.

Optionally, that the first network element discovers a third network element based on the first message includes at least one of the following:
the first network element discovers, based on the first information, a third network element whose exposing sensing data information matches the first information;
the first network element discovers, based on the second information, a third network element whose sensing service category matches the second information; or
the first network element discovers, based on the third information, a third network element whose sensing range matches the third information.

Optionally, the first information includes at least one of the following:
information used to indicate an expected sensing data category; or
information used to indicate an expected sensing data type.

Optionally, the method further includes:
sending, by the first network element, a second message to the second network element when the third network element is found, where the second message includes information used to indicate the third network element.

Optionally, the method further includes:
sending, by the first network element, a third message to the second network element when no network element that exposes the sensing data is found, where the third message is used to indicate that no network element that exposes the sensing data is found.

Optionally, the second message further includes at least one of the following information:
information used to indicate a sensing data category that the third network element supports exposing;
information used to indicate a sensing data type that the third network element supports exposing;
information used to indicate a sensing service category supported by the third network element; or
information used to indicate a sensing range supported by the third network element.

Optionally, the method further includes:
receiving, by the first network element, a fourth message from the third network element, where the fourth message is used to request to register related information of the third network element.

Optionally, the related information of the third network element includes at least one of the following:
fourth information, used to indicate exposing sensing data information of the third network element;
fifth information, used to indicate a sensing service category supported by the third network element; or
sixth information, used to indicate a sensing range supported by the third network element.

Optionally, the exposing sensing data information includes at least one of the following: the information used to indicate the sensing data category that the third network element supports exposing; or
the information used to indicate the sensing data type that the third network element supports exposing.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

Optionally, the sensing data type includes at least one of received signal data, channel response data, signal strength data, delay data, Doppler data, angle data, weather monitoring data, intrusion detection data, target location data, action data, heartbeat data, or imaging result data.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the first network element includes a network repository function NRF, the second network element includes a network exposure function NEF, a network data analysis function NWDAF, or an application function AF, and the third network element includes a sensing function SF.

In conclusion, in this embodiment of this application, through the foregoing process, the network element that exposes the sensing data can be found. In this way, the sensing data can be provided by using the network element that exposes the sensing data, thereby reducing costs of obtaining the sensing data.

The network element discovering method provided in the embodiments of this application may be performed by a network element discovering apparatus. In the embodiments of this application, that the network element discovering apparatus performs the network element discovering method is used to as an example to describe the network element discovering apparatus provided in the embodiments of this application.

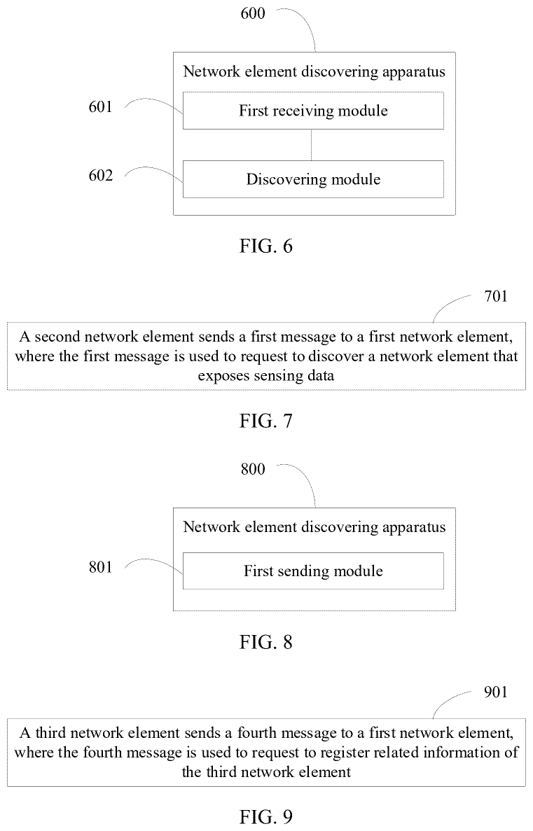

FIG. 6 is a structural diagram of a network element discovering apparatus according to an embodiment of this application. The network element discovering apparatus may be applied to a first network element. As shown in FIG. 6, a network element discovering apparatus 600 includes:
a first receiving module 601, configured to receive a first message from a second network element, where the first message is used to request to discover a network element that exposes sensing data; and
a discovering module 602, configured to discover a third network element based on the first message, where the third network element is the network element that exposes the sensing data.

Optionally, the first message includes at least one of the following information:
first information, used to indicate requirement information of the sensing data, where the first message is used to request to discover a network element whose exposing sensing data information matches the first information;
second information, used to indicate a sensing service category, where the first message is used to request to discover a network element whose sensing service category matches the second information; or
third information, used to indicate a sensing range, where the first message is used to request to discover a network element whose sensing range matches the third information.

Optionally, the discovering module 602 is specifically configured to perform at least one of the following:
discovering, based on the first information, a third network element whose exposing sensing data information matches the first information;
discovering, based on the second information, a third network element whose sensing service category matches the second information; or
discovering, based on the third information, a third network element whose sensing range matches the third information.

Optionally, the first information includes at least one of the following:
information used to indicate an expected sensing data category; or
information used to indicate an expected sensing data type.

Optionally, the network element discovering apparatus 600 further includes:
a first sending module, configured to send a second message to the second network element when the third network element is found, where the second message includes information used to indicate the third network element.

Optionally, the network element discovering apparatus 600 further includes:
a second sending module, configured to send a third message to the second network element when no network element that exposes the sensing data is found, where the third message is used to indicate that no network element that exposes the sensing data is found.

Optionally, the second message further includes at least one of the following information:
information used to indicate a sensing data category that the third network element supports exposing;
information used to indicate a sensing data type that the third network element supports exposing;
information used to indicate a sensing service category supported by the third network element; or
information used to indicate a sensing range supported by the third network element.

Optionally, the network element discovering apparatus 600 further includes:
a second receiving module, configured to receive a fourth message from the third network element, where the fourth message is used to request to register related information of the third network element.

Optionally, the related information of the third network element includes at least one of the following:
fourth information, used to indicate exposing sensing data information of the third network element;
fifth information, used to indicate a sensing service category supported by the third network element; or
sixth information, used to indicate a sensing range supported by the third network element.

Optionally, the exposing sensing data information includes at least one of the following:
the information used to indicate the sensing data category that the third network element supports exposing; or
the information used to indicate the sensing data type that the third network element supports exposing.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

Optionally, the sensing data type includes at least one of received signal data, channel response data, signal strength data, delay data, Doppler data, angle data, weather monitoring data, intrusion detection data, target location data, action data, heartbeat data, or imaging result data.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the first network element includes a network repository function NRF, the second network element includes a network exposure function NEF, a network data analysis function NWDAF, or an application function AF, and the third network element includes a sensing function SF.

In conclusion, in this embodiment of this application, the network element that exposes the sensing data can be found. In this way, the sensing data can be provided by using the network element that exposes the sensing data, thereby reducing costs of obtaining the sensing data.

The network element discovering apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal, and the another device may be a server, a network attached storage (Network Attached Storage, NAS), or the like. This is not specifically limited in this embodiment of this application.

The network element discovering apparatus provided in this embodiment of this application can implement the processes implemented in the method embodiment in FIG. 5, and achieve a same technical effect. To avoid repetition, details are not provided herein again.

FIG. 7 is a flowchart of a network element discovering method according to an embodiment of this application. As shown in FIG. 7, the network element discovering method includes the following steps.

Step 701: A second network element sends a first message to a first network element, where the first message is used to request to discover a network element that exposes sensing data.

Optionally, the first message includes at least one of the following information:
first information, used to indicate requirement information of the sensing data, where the first message is used to request to discover a network element whose exposing sensing data information matches the first information;
second information, used to indicate a sensing service category, where the first message is used to request to discover a network element whose sensing service category matches the second information; or
third information, used to indicate a sensing range, where the first message is used to request to discover a network element whose sensing range matches the third information.

Optionally, the first information includes at least one of the following:
information used to indicate an expected sensing data category; or
information used to indicate an expected sensing data type.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

Optionally, the sensing data type includes at least one of received signal data, channel response data, signal strength data, delay data, Doppler data, angle data, weather monitoring data, intrusion detection data, target location data, action data, heartbeat data, or imaging result data.

Optionally, the method further includes:
receiving, by the second network element, a second message from the first network element, where the second message includes information used to indicate a third network element, and the third network element is the network element that exposes the sensing data.

Optionally, the third network element is a network element whose exposing sensing data information matches the first information;
or
the third network element is a network element whose sensing service category matches the second information;
or
the third network element is a network element whose sensing range matches the third information.

It should be noted that any one of the foregoing “or” may be understood as “and”. For example, the third network element is a network element whose exposing sensing data information matches the first information and whose sensing service category matches the second information; or the third network element is a network element whose exposing sensing data information matches the first information and whose sensing range matches the third information; or the third network element is a network element whose exposing sensing data information matches the first information, whose sensing service category matches the second information, and whose sensing range matches the third information.

Optionally, the method further includes:
receiving, by the second network element, a third message from the first network element, where the third message is used to indicate that a network element that exposes the sensing data is not found.

Optionally, the second message further includes at least one of the following information:
information used to indicate a sensing data category that the third network element supports exposing;
information used to indicate a sensing data type that the third network element supports exposing;
information used to indicate a sensing service category supported by the third network element; or
information used to indicate a sensing range supported by the third network element.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the method further includes:
sending, by the second network element, a fifth message to the third network element based on the second message, where the fifth message is used to request the sensing data; and
receiving, by the second network element, the sensing data from the third network element.

Optionally, the fifth message includes seventh information, and the seventh information is used to indicate expected sensing data.

Optionally, the first network element includes a network repository function NRF, the second network element includes a network exposure function NEF, a network data analysis function NWDAF, or an application function AF, and the third network element includes a sensing function SF.

Optionally, the second network element is an NEF.

Before the second network element sends the first message to the first network element, the method further includes:
receiving, by the second network element, a sixth message from a fourth network element, where the sixth message is used to request to discover a network element that exposes sensing data, and the fourth network element is an AF.

Optionally, after the receiving, by the second network element, a second message from the first network element, the method further includes:
sending, by the second network element, a seventh message to the fourth network element, where the seventh message includes the information used to indicate the third network element, and the third network element is the network element that exposes the sensing data.

Optionally, after the receiving, by the second network element, the sensing data from the third network element, the method further includes:
sending, by the second network element to the fourth network element, the sensing data received by the second network element.

In conclusion, in this embodiment of this application, through the foregoing process, the network element that exposes the sensing data can be found. In this way, the sensing data can be provided by using the network element that exposes the sensing data, thereby reducing costs of obtaining the sensing data.

The network element discovering method provided in the embodiments of this application may be performed by a network element discovering apparatus. In the embodiments of this application, that the network element discovering apparatus performs the network element discovering method is used to as an example to describe the network element discovering apparatus provided in the embodiments of this application.

FIG. 8 is a structural diagram of a network element discovering apparatus according to an embodiment of this application. The network element discovering apparatus may be applied to a second network element. As shown in FIG. 8, a network element discovering apparatus 800 includes:
a first sending module 801, configured to send a first message to a first network element, where the first message is used to request to discover a network element that exposes sensing data.

Optionally, the first message includes at least one of the following information:
first information, used to indicate requirement information of the sensing data, where the first message is used to request to discover a network element whose exposing sensing data information matches the first information;
second information, used to indicate a sensing service category, where the first message is used to request to discover a network element whose sensing service category matches the second information; or
third information, used to indicate a sensing range, where the first message is used to request to discover a network element whose sensing range matches the third information.

Optionally, the first information includes at least one of the following:
information used to indicate an expected sensing data category; or
information used to indicate an expected sensing data type.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

Optionally, the sensing data type includes at least one of received signal data, channel response data, signal strength data, delay data, Doppler data, angle data, weather monitoring data, intrusion detection data, target location data, action data, heartbeat data, or imaging result data.

Optionally, the network element discovering apparatus 800 further includes:
a first receiving module, configured to receive a second message from the first network element, where the second message includes information used to indicate a third network element, and the third network element is the network element that exposes the sensing data.

Optionally, the third network element is a network element whose exposing sensing data information matches the first information;
or
the third network element is a network element whose sensing service category matches the second information;
or
the third network element is a network element whose sensing range matches the third information.

Optionally, the network element discovering apparatus 800 further includes:
a second receiving module, configured to receive a third message from the first network element, where the third message is used to indicate that a network element that exposes the sensing data is not found.

Optionally, the second message further includes at least one of the following information:
information used to indicate a sensing data category that the third network element supports exposing;
information used to indicate a sensing data type that the third network element supports exposing;
information used to indicate a sensing service category supported by the third network element; or
information used to indicate a sensing range supported by the third network element.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the network element discovering apparatus 800 further includes:
a second sending module, configured to send a fifth message to the third network element based on the second message, where the fifth message is used to request the sensing data; and
a third receiving module, configured to receive the sensing data from the third network element.

Optionally, the fifth message includes seventh information, and the seventh information is used to indicate expected sensing data.

Optionally, the first network element includes a network repository function NRF, the second network element includes a network exposure function NEF, a network data analysis function NWDAF, or an application function AF, and the third network element includes a sensing function SF.

Optionally, the second network element is an NEF.

The network element discovering apparatus 800 further includes:
a fourth receiving module, configured to receive a sixth message from a fourth network element, where the sixth message is used to request to discover a network element that exposes the sensing data, and the fourth network element is an AF.

Optionally, the network element discovering apparatus 800 further includes:
a third sending module, configured to send a seventh message to the fourth network element, where the seventh message includes the information used to indicate the third network element, and the third network element is the network element that exposes the sensing data.

Optionally, the network element discovering apparatus 800 further includes:
a fourth sending module, configured to send the received sensing data to the fourth network element.

In conclusion, in this embodiment of this application, the network element that exposes the sensing data can be found. In this way, the sensing data can be provided by using the network element that exposes the sensing data, thereby reducing costs of obtaining the sensing data.

The network element discovering apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal, and the another device may be a server, a network attached storage (Network Attached Storage, NAS), or the like. This is not specifically limited in this embodiment of this application.

The network element discovering apparatus provided in this embodiment of this application can implement the processes implemented in the method embodiment in FIG. 7, and achieve a same technical effect. To avoid repetition, details are not provided herein again.

FIG. 9 is a flowchart of a network element registration method according to an embodiment of this application. As shown in FIG. 9, the network element registration method includes the following step.

Step 901: A third network element sends a fourth message to a first network element, where the fourth message is used to request to register related information of the third network element.

Optionally, the related information of the third network element includes at least one of the following:
fourth information, used to indicate exposing sensing data information of the third network element;
fifth information, used to indicate a sensing service category supported by the third network element; or
sixth information, used to indicate a sensing range supported by the third network element.

Optionally, the exposing sensing data information includes at least one of the following:
the information used to indicate the sensing data category that the third network element supports exposing; or
the information used to indicate the sensing data type that the third network element supports exposing.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the method further includes:
receiving, by the third network element, a fifth message from a second network element, where the fifth message is used to request sensing data; and
sending, by the third network element, the sensing data to the third network element based on the fifth message.

Optionally, the fifth message includes seventh information, and the seventh information is used to indicate expected sensing; and
the sensing data sent by the third network element matches the seventh information.

Optionally, the fifth message is used to request sensing data that matches the seventh information.

Optionally, the fifth message further includes an expected sensing service category, an expected sensing range, and/or the like.

Optionally, the third network element determines, based on the fifth message, sensing data information to be sent. For example, the third network element determines a sensing data category, a sensing data type, and the like based on the fifth message; the third network element determines a sensing service category, a sensing range, and the like based on the fifth message; and so on.

Optionally, after determining the sensing data information to be sent, the third network element requests another network element to collect the sensing data. The third network element requests another network element to collect, within a sensing range, data and the like required by a sensing service.

Optionally, after determining the sensing data information to be sent, the third network element processes the sensing data to meet the requested sensing data information. For example, collected raw data is processed as a sensing intermediate result, a sensing service result, and/or the like.

Optionally, the first network element includes a network repository function NRF, the second network element includes a network exposure function NEF, a network data analysis function NWDAF, or an application function AF, and the third network element includes a sensing function SF.

In conclusion, in this embodiment of this application, through the foregoing process, the network element that exposes the sensing data can be found. In this way, the sensing data can be provided by using the network element that exposes the sensing data, thereby reducing costs of obtaining the sensing data.

The network element registration method provided in this embodiment of this application may be performed by a network element registration apparatus. In the embodiments of this application, that the network element registration apparatus performs the network element registration method is used as an example to describe the network element registration apparatus provided in the embodiments of this application.

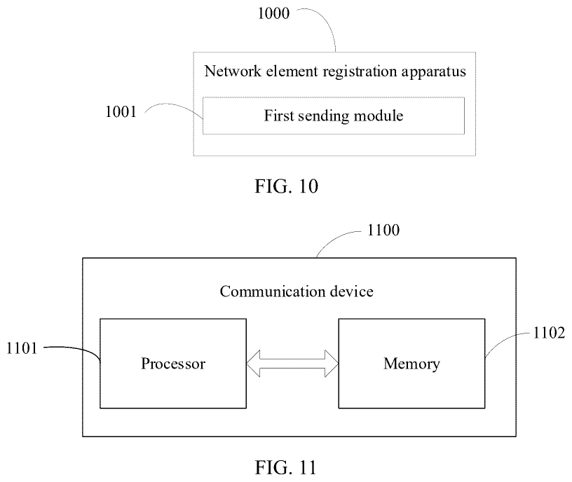

FIG. 10 is a structural diagram of a network element registration apparatus according to an embodiment of this application. The network element registration apparatus may be applied to a third network element. As shown in FIG. 10, a network element registration apparatus 1000 includes:
a first sending module 1001, configured to send a fourth message to a first network element, where the fourth message is used to request to register related information of the third network element.

Optionally, the related information of the third network element includes at least one of the following:
fourth information, used to indicate exposing sensing data information of the third network element;
fifth information, used to indicate a sensing service category supported by the third network element; or
sixth information, used to indicate a sensing range supported by the third network element.

Optionally, the exposing sensing data information includes at least one of the following:
the information used to indicate the sensing data category that the third network element supports exposing; or
the information used to indicate the sensing data type that the third network element supports exposing.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the network element registration apparatus 1000 further includes:
a first receiving module, configured to receive a fifth message from a second network element, where the fifth message is used to request the sensing data; and
a second sending module, configured to send the sensing data to the third network element based on the fifth message.

Optionally, the fifth message includes seventh information, and the seventh information is used to indicate expected sensing; and
the sensing data sent by the third network element matches the seventh information.

Optionally, the first network element includes a network repository function NRF, the second network element includes a network exposure function NEF, a network data analysis function NWDAF, or an application function AF, and the third network element includes a sensing function SF.

In conclusion, in this embodiment of this application, the network element that exposes the sensing data can be found. In this way, the sensing data can be provided by using the network element that exposes the sensing data, thereby reducing costs of obtaining the sensing data.

The network element registration apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal, and the another device may be a server, a network attached storage (Network Attached Storage, NAS), or the like. This is not specifically limited in this embodiment of this application.

The network element registration apparatus provided in this embodiment of this application can implement the processes implemented in the method embodiment in FIG. 9, and achieve a same technical effect. To avoid repetition, details are not provided herein again.

As shown in FIG. 11, an embodiment of this application further provides a communication device 1100, including a processor 1101 and a memory 1102, and the memory 1102 stores a program or instructions that are capable of being run on the processor 1101. For example, if the communication device 1100 is a terminal, when the program or the instructions are executed by the processor 1101, the steps of the foregoing embodiment of the network element discovering method are implemented, and a same technical effect can be achieved. If the communication device 1100 is a network side device, when the program or the instructions are executed by the processor 1101, the steps of the foregoing embodiment of the network element discovering method are implemented, and a same technical effect can be achieved. To avoid repetition, details are not described herein again.

An embodiment of this application further provides a first network element, including a processor and a communication interface. The communication interface is coupled to the processor, and the processor is configured to run a program or instructions, to implement the steps in the method embodiment shown in FIG. 5. This embodiment of the first network element corresponds to the foregoing method embodiment of the first network element. Each implementation process and implementation of the foregoing method embodiment may be applicable to this embodiment of the first network element, and a same technical effect can be achieved.

An embodiment of this application further provides a second network element, including a processor and a communication interface. The communication interface is coupled to the processor, and the processor is configured to run a program or instructions, to implement the steps in the method embodiment shown in FIG. 7. This embodiment of the second network element corresponds to the foregoing method embodiment of the second network element. Each implementation process and implementation of the foregoing method embodiment may be applicable to this embodiment of the second network element, and a same technical effect can be achieved.

An embodiment of this application further provides a third network element, including a processor and a communication interface. The communication interface is coupled to the processor, and the processor is configured to run a program or instructions, to implement the steps in the method embodiment shown in FIG. 9. This embodiment of the second network element corresponds to the foregoing method embodiment of the third network element. Each implementation process and implementation manner of the foregoing method embodiment may be applicable to this embodiment of the third network element, and a same technical effect can be achieved.

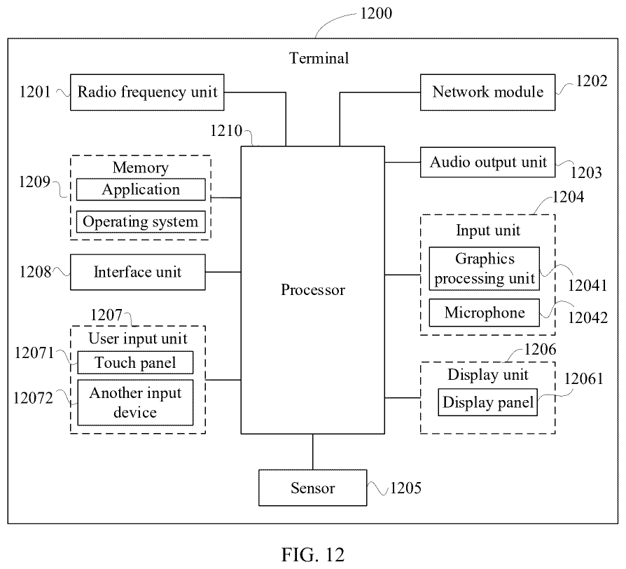

An embodiment of this application further provides a terminal, including a processor and a communication interface. The communication interface is coupled to the processor, and the processor is configured to run a program or instructions, to implement the steps in the method embodiment shown in FIG. 7 or FIG. 9. This terminal embodiment corresponds to the method embodiment on the second network element side or the method embodiment on the third network element side, each implementation process and implementation manner of the method embodiment can be applied to this terminal embodiment, and a same technical effect can be achieved. Specifically, FIG. 12 is a schematic diagram of a hardware structure of a terminal according to an embodiment of this application.

The terminal 1200 includes but is not limited to at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

It may be understood by a person skilled in the art that the terminal 1200 may further include a power supply (such as a battery) that supplies power to each component. The power supply may be logically connected to the processor 1210 by using a power management system, to implement functions such as charging, discharging, and power consumption management by using the power management system. The terminal structure shown in FIG. 12 constitutes no limitation on the terminal, and the terminal may include more or fewer components than those shown in the figure, or combine some components, or have different component arrangements. Details are not described herein.

It should be understood that in this embodiment of this application, the input unit 1204 may include a graphics processing unit (Graphics Processing Unit, GPU) 12041 and a microphone 12042. The graphics processing unit 12041 processes image data of a static picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may include a volatile memory or a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1209 in this embodiment of this application includes but is not limited to these memories and any memory of another proper type.

The processor 1210 may include one or more processing units. Optionally, an application processor and a modem processor are integrated into the processor 1210. The application processor mainly processes an operating system, a user interface, an application, or the like. The modem processor mainly processes a wireless communication signal, for example, a baseband processor. It may be understood that, alternatively, the modem processor may not be integrated into the processor 1210.

In some embodiments, the terminal 1200 is a second network element.

The radio frequency unit 1201 is configured to:
send a first message to a first network element, where the first message is used to request to discover a network element that exposes sensing data.

Optionally, the first message includes at least one of the following information:
first information, used to indicate expected sensing data;
second information, used to indicate an expected sensing service category; or
third information, used to indicate an expected sensing range.

Optionally, the first information includes at least one of the following:
information used to indicate an expected sensing data category; or
information used to indicate an expected sensing data type.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

Optionally, the sensing data type corresponds to an event identifier of the sensing data.

Optionally, the radio frequency unit 1201 is further configured to:
receive a second message from the first network element, where the second message includes information used to indicate a third network element, and the third network element is the network element that exposes the sensing data.

Optionally, the third network element is a network element whose exposing sensing data information matches the first information;
or
the third network element is a network element whose sensing service category matches the second information;
or
the third network element is a network element whose sensing range matches the third information.

Optionally, the second message further includes at least one of the following information:
information used to indicate a sensing data category that the third network element supports exposing;
information used to indicate a sensing data type that the third network element supports exposing;
information used to indicate a sensing service category supported by the third network element; or
information used to indicate a sensing range supported by the third network element.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the radio frequency unit 1201 is further configured to:
send a fifth message to the third network element based on the second message, where the fifth message is used to request the sensing data; and
receive the sensing data from the third network element.

Optionally, the fifth message includes seventh information, and the seventh information is used to indicate expected sensing data.

Optionally, the first network element includes a network repository function NRF, the second network element includes a network exposure function NEF, a network data analysis function NWDAF, or an application function AF, and the third network element includes a sensing function SF.

Optionally, the second network element is an NEF.

The radio frequency unit 1201 is further configured to:
receive a sixth message from a fourth network element, where the sixth message is used to request to discover a network element that exposes sensing data, and the fourth network element is an AF.

Optionally, the radio frequency unit 1201 is further configured to:
send a seventh message to the fourth network element, where the seventh message includes the information used to indicate the third network element, and the third network element is the network element that exposes the sensing data.

Optionally, the radio frequency unit 1201 is further configured to:
send, to the fourth network element, the sensing data received by the second network element.

In some embodiments, the terminal 1200 is a third network element.

The radio frequency unit 1201 is configured to:
send a fourth message to a first network element, where the fourth message is used to request to register related information of the third network element.

Optionally, the related information of the third network element includes at least one of the following:
fourth information, used to indicate information about sensing data that the third network element supports exposing;
fifth information, used to indicate a sensing service category supported by the third network element; or
sixth information, used to indicate a sensing range supported by the third network element.

Optionally, the fourth information includes at least one of the following:
the information used to indicate a sensing data category that the third network element supports exposing; or
the information used to indicate the sensing data type that the third network element supports exposing.

Optionally, the sensing range includes at least one of a time range for providing a sensing service, a region range for providing a sensing service, or a sensing precision range.

Optionally, the sensing precision range includes at least one of a sensing processing precision range or a sensing region precision range.

Optionally, the radio frequency unit 1201 is further configured to:
receive a fifth message from a second network element, where the fifth message is used to request sensing data; and
send the sensing data to the third network element based on the fifth message.

Optionally, the fifth message includes seventh information, and the seventh information is used to indicate expected sensing; and
the sensing data sent by the third network element matches the seventh information.

Optionally, the seventh information includes at least one of the following:
information used to indicate an expected sensing data category; or
information used to indicate an expected sensing data type.

Optionally, the sensing data category includes at least one of the following:
sensing measurement data, where the sensing measurement data is data obtained by a sensing measurement device by measuring a sensing signal or channel information;
sensing intermediate data, where the sensing intermediate data is data obtained by processing the sensing measurement data;
a sensing service result, where the sensing service result is service layer data obtained by processing the sensing measurement data or the sensing intermediate data; or
a container category, used to indicate to store the sensing data based on a container.

Optionally, the sensing data type corresponds to an event identifier of the sensing data.

Optionally, the first network element includes a network repository function NRF, the second network element includes a network exposure function NEF, a network data analysis function NWDAF, or an application function AF, and the third network element includes a sensing function SF.

In conclusion, in this embodiment of this application, the network element that exposes the sensing data can be found. In this way, the sensing data can be provided by using the network element that exposes the sensing data, thereby reducing costs of obtaining the sensing data.

An embodiment of this application further provides an access network device, including a processor and a communication interface. The communication interface is coupled to the processor, and the processor is configured to run a program or instructions, to implement the steps in the method embodiment shown in FIG. 9. This access network device embodiment corresponds to the foregoing method embodiment on the third network element side. Each implementation process and implementation manner of the foregoing method embodiment may be applicable to this access network device embodiment, and a same technical effect can be achieved.

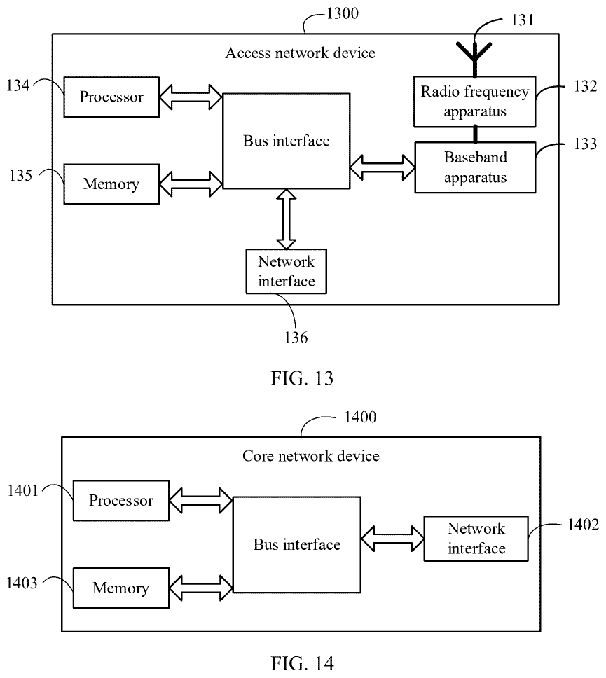

Specifically, an embodiment of this application further provides an access network device. As shown in FIG. 13, an access network device 1300 includes an antenna 131, a radio frequency apparatus 132, a baseband apparatus 133, a processor 134, and a memory 135. The antenna 131 is connected to the radio frequency apparatus 132. In an uplink direction, the radio frequency apparatus 132 receives information through the antenna 131, and sends the received information to the baseband apparatus 133 for processing. In a downlink direction, the baseband apparatus 133 processes information that needs to be sent, and sends processed information to the radio frequency apparatus 132. The radio frequency apparatus 132 processes the received information, and sends processed information through the antenna 131.

In the foregoing embodiment, the method performed by the access network device may be implemented in the baseband apparatus 133. The baseband apparatus 133 includes a baseband processor.

For example, the baseband apparatus 133 may include at least one baseband board. A plurality of chips are disposed on the baseband board. As shown in FIG. 13, one chip is, for example, a baseband processor, and is connected to the memory 135 by using a bus interface, to invoke a program in the memory 135 to perform the operations of the network device shown in the foregoing method embodiment.

The access network device may further include a network interface 136, and the interface is, for example, a common public radio interface (Common Public Radio Interface, CPRI).

Specifically, the access network device 1300 in this embodiment of this application further includes instructions or a program that is stored in the memory 135 and that can be run on the processor 134. The processor 134 invokes the instructions or the program in the memory 135 to perform the method performed by the modules shown in FIG. 10, and a same technical effect is achieved. To avoid repetition, details are not described herein again.

An embodiment of this application further provides a core network device. As shown in FIG. 14, a core network device 1400 includes a processor 1401, a network interface 1402, and a memory 1403. The network interface 1402 is, for example, a common public radio interface (common public radio interface, CPRI).

Specifically, the core network device 1400 in this embodiment of this application further includes instructions or a program that is stored in the memory 1403 and that can be run on the processor 1401, and the processor 1401 invokes the instructions or the program in the memory 1403 to perform the method performed by the modules shown in FIG. 6 or FIG. 8, and a same technical effect is achieved. To avoid repetition, details are not described herein again.

An embodiment of this application further provides a readable storage medium. The readable storage medium stores a program or instructions, and when the program or the instructions are executed by a processor, the processes of the foregoing embodiment of the network element discovering method are implemented, or the processes of the foregoing embodiment of the network element registration method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or instructions to implement the processes of the foregoing embodiment of the network element discovering method or implement the processes of the foregoing embodiment of the network element registration method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the network element discovering method or implement the processes of the foregoing embodiment of the network element registration method, and a same technical effect can be achieved. To avoid repetition, details are not described herein again.

An embodiment of this application further provides a communication system, including a first network element, a second network element, and a third network element. The first network element may be configured to perform the steps of the foregoing network element discovering method, the second network element may be configured to perform the steps of the foregoing network element discovering method, and the third network element may be configured to perform the steps of the foregoing network element registration method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or certainly by hardware. The computer software product is stored in a storage medium (such as a ROM, a RAM, a magnetic disk, or an optical disc), and includes several instructions for instructing a terminal or a network side device to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of which fall within the protection of this application.

1. A network element discovering method, comprising:
receiving, by a first network element, a first message from a second network element, wherein the first message is used to request to discover a network element that exposes sensing data; and
discovering, by the first network element, a third network element based on the first message, wherein the third network element is the network element that exposes the sensing data.

2. The method according to claim 1, wherein the first message comprises at least one of the following information:
first information, used to indicate expected sensing data;
second information, used to indicate an expected sensing service category; or
third information, used to indicate an expected sensing range.

3. The method according to claim 2, wherein the discovering, by the first network element, a third network element based on the first message comprises at least one of the following:
discovering, by the first network element based on the first information, a third network element whose exposing sensing data information matches the first information;
discovering, by the first network element based on the second information, a third network element whose sensing service category matches the second information; or
discovering, by the first network element based on the third information, a third network element whose sensing range matches the third information.

4. The method according to claim 2 wherein the first information comprises at least one of the following:
information used to indicate an expected sensing data category; or
information used to indicate an expected sensing data type.

5. The method according to claim 1, wherein the method further comprises:
sending, by the first network element, a second message to the second network element when the third network element is found, wherein the second message comprises information used to indicate the third network element.

6. The method according to claim 5, wherein the second information further comprises any one of the following information:
information used to indicate a sensing data category that the third network element supports exposing;
information used to indicate a sensing data type that the third network element supports exposing;
information used to indicate a sensing service category supported by the third network element; and
information used to indicate a sensing range supported by the third network element.

7. The method according to claim 1, wherein the method further comprises:
receiving, by the first network element, a fourth message from the third network element, wherein the fourth message is used to request to register related information of the third network element;
wherein the related information of the third network element comprises at least one of the following:
fourth information, used to indicate information about sensing data that the third network element supports exposing;
fifth information, used to indicate a sensing service category supported by the third network element; or
sixth information, used to indicate a sensing range supported by the third network element;
wherein the fourth information comprises at least one of the following:
information used to indicate a sensing data category that the third network element supports exposing; or
information used to indicate a sensing data type that the third network element supports exposing.

8. The method according to claim 4, wherein the sensing data category comprises at least one of the following:
sensing measurement data, wherein the sensing measurement data is data obtained by a sensing measurement device by measuring a sensing signal or channel information;
sensing intermediate data, wherein the sensing intermediate data is data obtained by processing the sensing measurement data;
a sensing service result, wherein the sensing service result is service layer data obtained by processing the sensing measurement data or the sensing intermediate data; or
a container category, used to indicate to store the sensing data based on a container; or
wherein the sensing data type corresponds to an event identifier of the sensing data.

9. The method according to claim 2, wherein the sensing range comprises at least one of a time range for providing a sensing service, a region range for providing a sensing service, or a sensing precision range.

10. The method according to claim 9, wherein the sensing precision range comprises at least one of a sensing processing precision range or a sensing region precision range.

11. The method according to claim 1, wherein the first network element comprises a network repository function (NRF), the second network element comprises a network exposure function (NEF), a network data analysis function (NWDAF), or an application function (AF), and the third network element comprises a sensing function (SF).

12. A network element discovering method, comprising:
sending, by a second network element, a first message to a first network element, wherein the first message is used to request to discover a network element that exposes sensing data.

13. The method according to claim 12, wherein the first message comprises at least one of the following information:
first information, used to indicate expected sensing data;
second information, used to indicate an expected sensing service category; and
third information, used to indicate an expected sensing range.

14. The method according to claim 12, wherein the method further comprises:
receiving, by the second network element, a second message from the first network element, wherein the second message comprises information used to indicate a third network element, and the third network element is the network element that exposes the sensing data.

15. The method according to claim 14, wherein the method further comprises:
sending, by the second network element, a fifth message to the third network element based on the second message, wherein the fifth message is used to request the sensing data; and
receiving, by the second network element, the sensing data from the third network element.

16. A network element registration method, comprising:
sending, by a third network element, a fourth message to a first network element, wherein the fourth message is used to request to register related information of the third network element.

17. The method according to claim 16, wherein the related information of the third network element comprises at least one of the following:
fourth information, used to indicate information about sensing data that the third network element supports exposing;
fifth information, used to indicate a sensing service category supported by the third network element; and
sixth information, used to indicate a sensing range supported by the third network element;
wherein the fourth information comprises at least one of the following:
information used to indicate a sensing data category that the third network element supports exposing; and
information used to indicate a sensing data type that the third network element supports exposing.

18. A communication device, comprising a processor and a memory, wherein the memory stores a program or instructions executable on the processor, and the program or the instructions, when executed by the processor, cause the processor to implement the network element discovering method according to claim 1.

19. A communication device, comprising a processor and a memory, wherein the memory stores a program or instructions executable on the processor, and the program or the instructions, when executed by the processor, cause the processor to implement the network element discovering method according to claim 12.

20. A communication device, comprising a processor and a memory, wherein the memory stores a program or instructions executable on the processor, and the program or the instructions, when executed by the processor, cause the processor to implement the network element registration method according to claim 16.
